(19) United States
(12) Patent Application Publication
(10) Pub. No.: US 2017/0030341 A1
(43) Pub. Date: Feb. 2, 2017

(54) MULTI-PLUNGER CRYOGENIC PUMP HAVING INTAKE MANIFOLD

(71) Applicant: Caterpillar Inc., Peoria, IL (US)

(72) Inventors: Shivangini S. HAZARI, Peoria, IL (US); Cory A. BROWN, Peoria, IL (US); Joshua W. STEFFEN, El Paso, IL (US); Sunil J. BEAN, Peoria, IL (US)

(73) Assignee: Caterpillar Inc., Peoria, IL (US)

(21) Appl. No.: 14/810,372

(22) Filed: Jul. 27, 2015

(51) Int. Cl. F04B 15/08; F04B 1/12; F17C 7/02

(52) U.S. Cl. CPC F04B 15/08; F17C 7/02; F04B 1/122; F04B 1/128; F17C 2221/033; F17C 2227/0142; F04B 2015/081

(57) ABSTRACT

A cryogenic pump is disclosed as having a plunger housing with a plurality of barrels formed in a ring around a central axis, and a plurality of plungers. Each of the plurality of plungers may be reciprocatingly disposed within a different one of the plurality of barrels. The cryogenic pump may also include an inlet manifold connected to the plunger housing and having a plurality of bores. Each of the plurality of bores may be open to a corresponding one of the plurality of barrels. The cryogenic pump may also have at least one orifice in fluid communication with each of the plurality of bores, and an inlet check valve disposed between each of the plurality of bores and the at least one orifice. The inlet check valve may be movable to selectively allow flow between the at least one orifice and a corresponding one of the plurality of barrels.

### TECHNICAL FIELD

This disclosure relates generally to a manifold and, more particularly, to a manifold for a multi-plunger cryogenic in-tank pump.

### BACKGROUND

Gaseous fuel powered engines are common in many applications. For example, the engine of a locomotive can be powered by natural gas (or another gaseous fuel) alone or by a mixture of natural gas and diesel fuel. Natural gas may be more abundant and, therefore, less expensive than diesel fuel. In addition, natural gas may burn cleaner in some application, and produce less greenhouse gas.

Natural gas, when used in a mobile application, may be stored in a liquid state onboard the associated machine. This may require the natural gas to be stored at cold temperatures, typically about −100 to −162° C. The liquefied natural gas is then drawn from the tank by gravity (and/or by a boost pump) and directed to a high-pressure pump. The high-pressure pump further increases a pressure of the fuel and directs the fuel to the machine's engine. In some applications, the liquid fuel may be gasified prior to injection into the engine and/or mixed with diesel fuel (or another fuel) before combustion.

One problem associated with pumps operating at cryogenic temperatures involves flash boiling of the natural gas due to low pressures observed during retracting strokes of the pump's pistons. In order to avoid such low pressures, and thereby avoid flash boiling of the natural gas, modern cryogenic pump systems incorporate pistons submerged within liquid fuel at the bottom of the tank. Each piston is connected with an inlet check valve that allows low-pressure fuel from the tank to enter an associated barrel, and with an outlet check valve that allows high-pressure fuel to be discharged from the barrel. These valves are typically packaged together within a separate head assembly associated with each piston.

An exemplary cryogenic pump is disclosed in U.S. Pat. No. 4,576,557 that issued to Pevzner on Mar. 18, 1986 (“the '557 patent”). The pump of the '557 patent is a reciprocating-type pump having a pumping section with three plungers that are each connected to a crankshaft. As the crankshaft rotates, the plungers are caused to reciprocate within the pumping section. A valve assembly is associated with each of the plungers and separately mounted to the pumping section. Each valve assembly includes a discharge valve and a suction valve.

While the conventional cryogenic pump having separate head or valve assemblies may be suitable for some applications, it may also be problematic for other applications. In particular, the separate head or valve assemblies can require a significant amount of space at the pump. There may not be enough space for these assemblies in some applications.

The disclosed pump and manifold are directed to overcoming one or more of the problems set forth above and/or other problems of the prior art.

### SUMMARY

In one aspect, the present disclosure is directed to a liner for a cryogenic pump having a manifold. The liner may include a generally cylindrical body having a top end and a bottom end, and an internal bore formed in the generally cylindrical body and passing from the top end through the bottom end. The internal bore may be configured to receive a plunger of the cryogenic pump. The liner may also include a flange located at the top end and configured to be used to connect the generally cylindrical body to a barrel of the manifold.

In one aspect, the present disclosure is directed to a manifold for a cryogenic pump. The manifold may include a generally cylindrical body having a top end and a bottom end, and a plurality of bores arranged in a ring around a central axis of the generally cylindrical body. Each of the plurality of bores may be configured to communicate with a different plunger barrel of the cryogenic pump. The manifold may also include at least one inlet orifice in fluid communication with each of the plurality of bores.

In another aspect, the present disclosure is directed to a cryogenic pump. The cryogenic pump may include a plunger housing with a plurality of barrels formed in a ring around a central axis, and a plurality of plungers. Each of the plurality of plungers may be reciprocatingly disposed within a different one of the plurality of barrels. The cryogenic pump may also include an inlet manifold connected to an end of the plunger housing and having a plurality of bores. Each of the plurality of bores may be open to a corresponding one of the plurality of barrels. The cryogenic pump may also include at least one orifice in fluid communication with each of the plurality of bores, and an inlet check valve disposed within the inlet manifold between each of the plurality of bores and the at least one orifice. The inlet check valve may be movable to selectively allow fluid flow between the at least one orifice and a corresponding one of the plurality of barrels.

### BRIEF DESCRIPTION OF THE DRAWINGS

FIG. 1 is a diagrammatic illustration of an exemplary disclosed pumping system;

FIG. 2 is a cross-sectional illustration of an exemplary disclosed pump manifold that may be used in conjunction with the pumping system of FIG. 1;

FIG. 3 is a cross-sectional illustration of another exemplary disclosed pump manifold that may be used in conjunction with the pumping system of FIG. 1; and

FIG. 4 is a cross-sectional illustration of another exemplary disclosed pump manifold that may be used in conjunction with the pumping system of FIG. 1.

### DETAILED DESCRIPTION

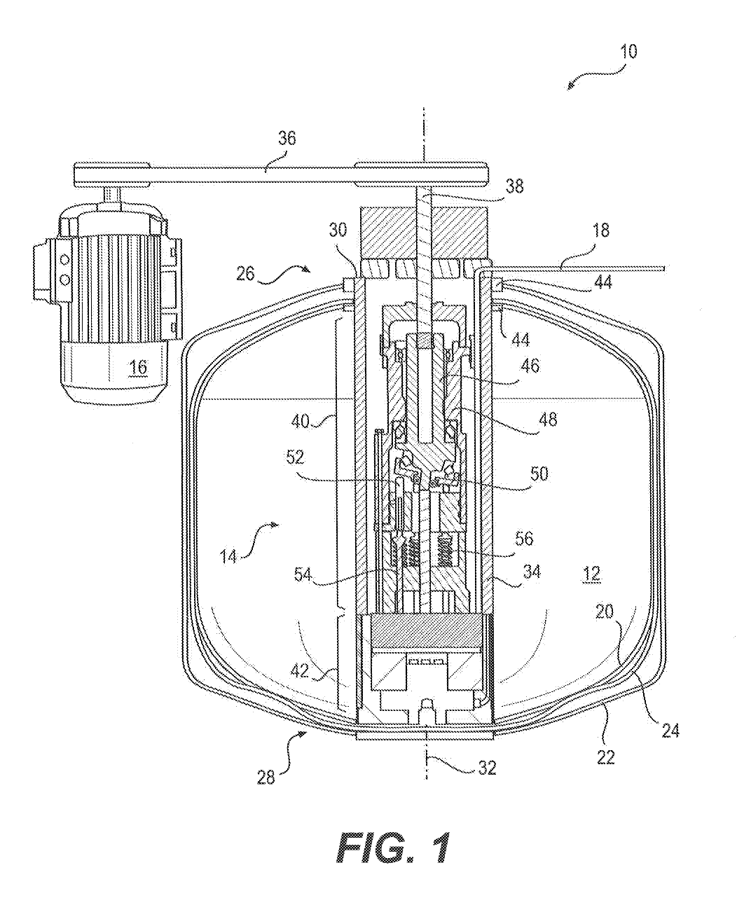

FIG. 1 illustrates an exemplary pumping system 10 having multiple components that cooperate to provide a gaseous fluid (e.g., natural gas) to a consumer (e.g., to an engine—not shown) in a regulated manner. These components may include, among other things, a tank 12, a pump 14, and a power source 16. A liquid (e.g., liquefied natural gas—LNG) may be stored in tank 12, and pump 14 may be driven by power source 16 to draw in and pressurize the liquid. The pressurized liquid may be directed via a passage 18 to the consumer alone or together with another liquid (e.g., together with another liquid fuel, such as diesel). It is contemplated that pumping system 10 could have additional components (e.g., pressure regulating devices, vaporizers, accumulators, etc.), if desired.

Tank 12 may be a cryogenic tank configured to hold fluid in its liquefied state. In the exemplary embodiment, tank 12 has one or more inner walls 20 separated from one or more outer walls 22 by an air gap. In some embodiments, an insulating layer 24 may be disposed in the air gap (e.g. on inner wall 20). The air gap, together with insulating layer 24, may function to maintain a temperature of the liquid below its boiling threshold of about −100° C. to −162° C. (i.e., depending on a pressure inside tank 12).

Tank 12 may be generally cylindrical, having a top 26 and a bottom 28. An opening 30 may be formed in top 26 that passes through both of inner and outer walls 20, 22. Opening 30 may be generally aligned with a central axis 32 of symmetry. Bottom 28 may be closed.

Pump 14 may be at least partially submerged inside of tank 12, for example inside a centralized socket 34 formed in tank 12. In particular, pump 14 may hang from top 26 of tank 12 a distance below a fluid level therein. By being connected to tank 12 at only one end, pump 14 may be allowed to expand and contract due to normal thermal loading without inducing stresses in tank 12 that could damage tank 12 and/or pump 14. Power source 16 may be located outside of tank 12, and connected to drive pump 14 via a belt 36 and a mechanical input 38. In the disclosed embodiment, power source 16 is an electric motor and mechanical input 38 is a shaft. In other exemplary embodiments, however, power source 16 could be the consumer receiving fuel from pump 14 (or another power source) and/or mechanical input 38 could be a gear train, if desired. In either of these arrangements, an output rotation of power source 16 may cause belt 36 to induce a corresponding input rotation of mechanical input 38.

Pump 14 may be generally cylindrical and divided into two ends. For example, pump 14 may be divided into a warm or input end 40, into which mechanical input 38 extends, and a cold or output end 42 that is at least partially submerged in the fluid. Warm end 40 may be fixedly mounted to tank 12 at top 26, for example by way of one or more mounting hardware components 44 (e.g., flanges, seals, brackets, gaskets, etc.). Warm end 40 may be insulated and/or isolated from cold end 42 (e.g., encased in vacuum jacket or super insulated liner that inhibits heat transfer). Cold end 42 may extend from warm end 40 deeper into tank 12. With this configuration, the input rotation provided to pump 14 at warm end 40 (i.e., via mechanical input 38) may be used to generate a high-pressure discharge at the opposing cold end 42. The high-pressure discharge may be directed back up past warm end 40 via passage 18 to exit tank 12 at opening 30. In most applications, pump 14 will be mounted and used in the orientation shown in FIG. 1 (i.e., with cold end 42 being located gravitationally lowest).

Pump 14 may be an axial piston type of pump. In particular, a pump shaft 46 may be rotatably supported within a housing 48, and connected at a top end to mechanical input 38 (e.g., via a splined interface) and at a bottom end to a load plate 50. Load plate 50 may be oriented at an oblique angle relative to axis 32, such that the input rotation of shaft 46 may be converted into a corresponding undulating motion of load plate 50. A plurality of tappets 52 may slide along a lower face of load plate 50, and a push rod 54 may be associated with each tappet 52. In this way, the undulating motion of load plate 50 may be transferred linearly through tappets 52 to push rods 54 and used to pressurize the fluid passing through cold end 42. A resilient member, for example a coil spring 56, may be associated with each push rod 54 and configured to bias the associated tappet 52 into engagement with load plate 50. Each push rod 54 may be a single-piece component or, alternatively, be comprised of multiple pieces, as desired. Many different shaft/load plate configurations may be possible, and the oblique angle of load plate 50 may be fixed or variable, as desired. In the disclosed embodiment, the oblique angle of load plate 50 is fixed, and a variable output of pump 14 is obtained via speed adjustment of power source 16.

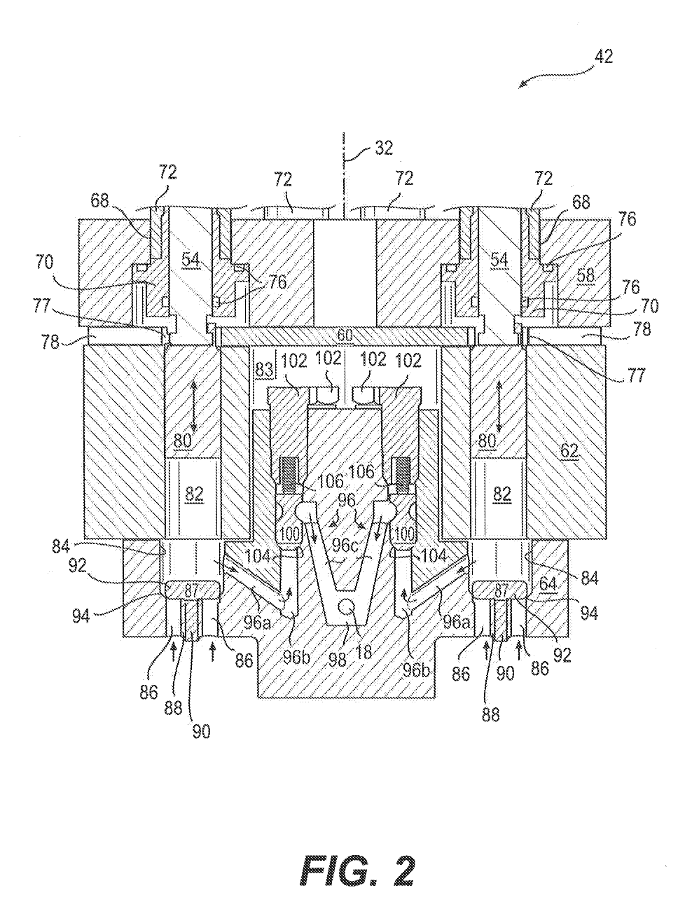

Cold end 42 of pump 14 may be an assembly of different components that performs several different functions. In particular, cold end 42 may function as a guide for push rods 54, as a pumping mechanism, and as a distributer/collector of low- and high-pressure fluids. Several different cold end embodiments are included in this disclosure and depicted in FIGS. 2-4.

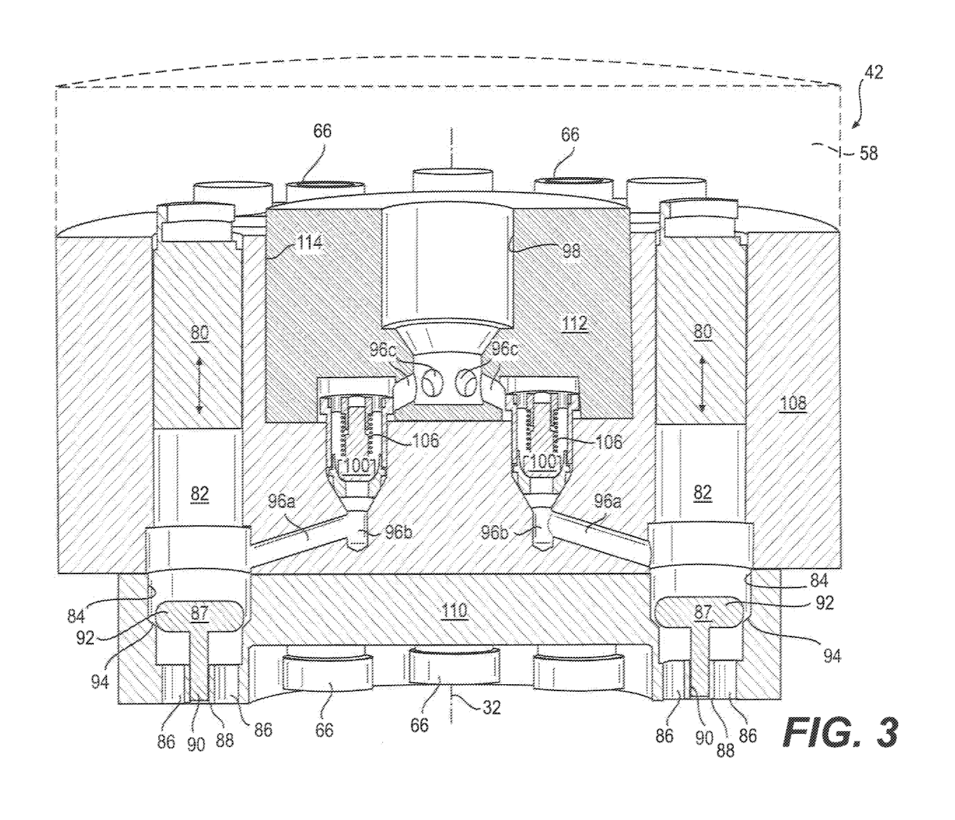

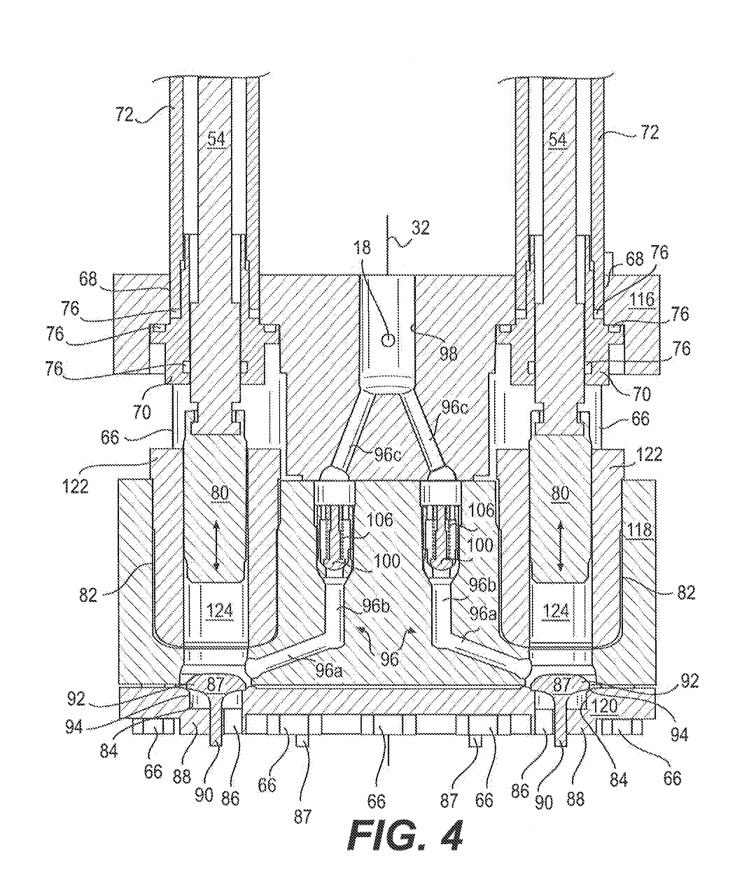

As shown in the embodiment of FIG. 2, cold end 42 may include, among other things, a connecting flange 58, a spacer plate 60, a plunger housing 62, and a manifold 64. Connecting flange 58 may be coupled between a submerged portion of warm end 40 and an upper end of spacer plate 60. Plunger housing 62 may be coupled to a lower end of spacer plate 60 opposite connecting flange 58. A top end of manifold 64 may be coupled to a distal end of plunger housing 62. A plurality of fasteners 66 (shown only in FIGS. 3 and 4) may pass through or into each of these components, thereby connecting the components to each other.

Connecting flange 58 may function to connect cold end 42 to warm end 40 and also as a lower-end guide for push rods 54. In particular, connecting flange 58 may have a generally cylindrical body, with a plurality of bores 68 formed therein and arranged in a ring around axis 32. Each of bores 68 may be configured to receive a different guide nut 70. In one embodiment, connecting flange 58 is fastened to an end of housing 48 (e.g., via fasteners 66 or other fasteners—not shown), thereby connecting cold end 42 to warm end 40. In another embodiment, a plurality of push rod sleeves 72 (shown only in FIG. 2) are threadingly engaged with guide nuts 70, thereby connecting cold end 42 to warm end 40. In either embodiment, guide nuts 70 may function to guide the lower ends of push rods 54. One or more seals (e.g., liquid and/or vapor seals) 76 may be disposed between guide nuts 70 and walls of bore 68, if desired.

Spacer plate 60, like connecting flange 58, may also have a generally cylindrical body with a plurality of bores 77 formed in a ring around axis 32. Spacer plate 60 may function as a spacer between connecting flange 58 and plunger housing 62 and provide for unrestricted leak paths 78 to bores 77. Accordingly, the body of spacer plate 60 may be relatively plate-like. Leak paths 78 may extend radially outward from each bore 77 to an outer periphery of spacer plate 60. With this configuration, any fuel leaking from manifold 64 at the distal ends of push rods 54 may be allowed to return uninhibited to tank 12 via leak paths 78.

Plunger housing 62 may function to house a plurality of plungers 80 and, together with plungers 80, form a plurality of different pumping mechanisms. Specifically, plunger housing 62 may have a generally cylindrical body, with a plurality of hollow barrels 82 formed therein in a ring around axis 32. Barrels 82 may be open to and aligned with bores 77 of spacer plate 60 and bores 68 of connecting flange 58. One plunger 80 may be slidingly disposed within each barrel 82 and engaged with the distal end of a corresponding push rod 54. In this way, an extending movement of push rod 54 may translate into a downward sliding motion of a corresponding plunger 80 toward a Bottom-Dead-Center (BDC) position. A pressure of the fuel in tank 12 and in barrel 82 may help to return plunger 80 to a Top-Dead-Center (TDC) position as push rod 54 is retracted from barrel 82. In one example, push rod 54 is disconnected from plunger 80 (i.e., plunger 80 is a free-floating plunger). In another example, push rod 54 is loosely connected to plunger 80, such that a retracting motion of push rod 54 functions to assist the upward movement of plunger 80 within barrel 82. The cylindrical body of plunger housing 62 may have a central cavity 83 disposed inward of barrels 82 and aligned with axis 32. Central cavity 83 may be configured to receive a portion of manifold 64.

Manifold 64 may house a plurality of valves that are movable to allow fluid into each barrel 82 during movement of the corresponding plungers 80. In particular, manifold 64 may have a generally cylindrical body, with a plurality of bores 84 formed therein that are open to and generally aligned with barrels 82 of plunger housing 62. Each bore 84 may be in communication with tank 12 (e.g., via one or more orifices 86) at a bottom end of manifold 64 and house a separate inlet check valve 87. Orifices 86 may be generally parallel with an axis of its corresponding bore 84, and arranged in a ring around a center valve guide 88. A stem 90 of each inlet check valve 87 may be slidingly disposed within a corresponding one of guides 88, such that as check valve 87 moves from a closed position (shown in FIG. 2) to an open position, orifices 86 are communicated with the corresponding bore 84 to allow fluid into barrel 82. In one embodiment, a base 92 of each inlet check valve 87 may be configured to engage a seat 94 of bore 84 when inlet check valve 87 is in the closed position. It is contemplated that other inlet check valve configurations may be possible.

The cylindrical body of manifold 64 may be stepped, with inlet check valves 87 arranged in a flange portion that surrounds an inwardly protruding center portion. The inwardly protruding center portion may be recessed completely within cavity 83 of plunger housing 62, while the flange portion may abut the lower end of plunger housing 62. After drawing low-pressure fluid into barrels 82 via inlet check valves 87, a subsequent extending movement of plungers 80 may function to discharge high-pressure fluid out of barrels 82. The high-pressure discharge from all barrels 82 may join each other inside the center portion of manifold 64 for radial discharge from manifold 64 (and ultimately from pump 14) via passage 18. In particular, one or more passages 96 may extend through the flange and center portions of manifold 64 to connect each barrel 82 with a central discharge cavity 98, which is in fluid communication with passage 18.

An outlet check valve 100 may be disposed within each passage 96 to help ensure a unidirectional flow of fluid from barrels 82 into cavity 98. Outlet check valves 100 may be disposed in the center portion of manifold 64 and arranged in a ring around axis 32. In the disclosed embodiment, both inlet and outlet check valves 87, 100 are assembled into manifold 64 from the same internal end. Inlet check valves 87 may be retained inside manifold 64 by plunger housing 62 (or alternatively by way of dedicated threaded heads or pins inserted into stems 90 after assembly of stems 90 into guides 88), while outlet check valves 100 may be retained inside manifold 64 by associated plugs 102. In one embodiment, outlet check valves 100 may be biased against a seat 104 (i.e., biased into a closed position) by associated springs 106 located between outlet check valves 100 and plugs 102. When a pressure of fluid inside passages 96 (i.e., at a location between each barrel 82 and central cavity 98) creates a force on outlet check valves 100 that exceeds an opening force of springs 106, outlet check valves 100 may move away from seats 104 to allow flow through passages 96.

In some applications, a space inside tank 12 may be limited. In these applications, the amount of space (e.g., axial and/or radial space) consumed by manifold 64 may be important. For this reason, a size of manifold 64 may be reduced by strategically locating outlet check valves 100. In the disclosed embodiment of FIG. 2, outlet check valves 100 are located to overlap axially with barrels 82 and just far enough away from inlet check valves 87 to allow machining of passages 96. In one example, only a tip end of outlet check valves 100 (e.g., only about 0-25% of an axial length of outlet check valves 100) extends past a distal end of barrels 82. In this example, each passage 96 may be formed from three different segments, including a first segment 96a, a second segment 96b, and a third segment 96c. Segments 96a and 96c may both be oriented obliquely relative to axis 32, while segment 96b may be generally aligned with outlet check valve 100 and parallel with axis 32. The angle of segment 96a may allow for machining of segment 96a from the opening of bore 84, and the distance between inlet and outlet check valves 87, 100 may be selected to provide for this angle.

Another embodiment of cold end 42 is illustrated in FIG. 3. Like the cold end embodiment of FIG. 2, the cold end embodiment of FIG. 3 may include connecting flange 58 and spacer plate 60. However, for clarity, these components have been removed from the cold end embodiment of FIG. 3. In contrast to the embodiment of FIG. 2, cold end 42 of FIG. 3 may include a different plunger housing 108, an inlet manifold 110, and an outlet manifold 112. Plunger housing 108 may be sandwiched between inlet and outlet manifolds 110, 112 by fasteners 66.

Like plunger housing 62 of FIG. 2, plunger housing 108 of FIG. 3 may have a generally cylindrical body, with hollow barrels 82 formed therein in a ring around axis 32 to receive plungers 80. However, in contrast to plunger housing 62, a recess 114 may be formed between barrels 82 at only an upper or inward end that is configured to internally receive outlet manifold 112. In addition, outlet check valves 100 and springs 106 may be housed within a center of plunger housing 108 (e.g., at a location below outlet manifold 112), and portions of each passage 96 (e.g., segments 96a and 96b) may be routed through plunger housing 108 between barrels 82 and outlet check valves 100. It is contemplated that spacer plate 60 may or may not be included in plunger housing 108, as desired.

Inlet manifold 110 of FIG. 3, instead of having a flange portion and a protruding center portion like manifold 64 of FIG. 2, may be cylindrical and generally plate-like with a consistent axial thickness. Bores 84 may be formed therein to receive inlet check valves 87 in the same configuration of manifold 64. Stems 90 of inlet check valves 87 may be slidingly received within guides 88, and bases 92 may selectively engage seats 94 to inhibit high-pressure flow from exiting barrels 82 into tank 12 during the extending strokes of plungers 80.

Outlet manifold 112 may be generally cylindrical and fit almost entirely inside recess 114 of plunger housing 108. Outlet manifold 112 may be sealed against plunger housing 108 (e.g., by way of fasteners 66 shown at the bottom of inlet manifold 110), such that high-pressure fluid is retained in passages 96. Outlet manifold 112 may house central cavity 98 and portions of passages 96 (i.e., segments 96c) that extend from check valves 100 to central cavity 98. Passage 18 (not shown in FIG. 3) may communicate with central cavity 98 by way of a high-pressure fitting (not shown) that can be threaded into central cavity 98 from a side opposite plunger housing 108. It should also be noted that check valves 100 of FIG. 3 may take a different form than check valves 100 of FIG. 2, if desired. For example, check valves 100 of FIG. 2 may each be an axial flow-through type of valve, while check valves 100 of FIG. 3 may instead each be a side-flow type of valve. Other configurations may also be possible.

The cold end embodiment of FIG. 3 may have a more compact, cost-effective, and/or efficient design than the cold-end embodiment of FIG. 2. In particular, because central cavity 98 may be located within outlet manifold 112, which may be recessed within the inner end of plunger housing 62, the overall axial length of cold end 42 in the embodiment of FIG. 3 may be less. In addition, by dividing the functionality of manifold 64 between separate and smaller inlet and outlet manifolds 110, 112, these smaller components may be easier to fabricate and cheaper. Further, the configuration of passage segments 96a, 96b, 96c may be more continuous (i.e., the passage segments may not require as much flow redirection due to the type of check valves 100 used), allowing for a more efficient flow of fluid between barrels 82 and central cavity 83.

While the cold end embodiment of FIG. 3 may have some advantages over the embodiment of FIG. 2, the embodiment of FIG. 2 may also have some advantages over the embodiment of FIG. 3. In particular, the embodiment of FIG. 2 includes only two main components that need to be sealed together with at a single high-pressure interface (i.e., between plunger housing 62 and manifold 64. The embodiment of FIG. 3, however, includes four main components that seal at three high-pressure interfaces. The increased number of high-pressure interfaces of the FIG. 3 embodiment may relate to an increase in costly precision that creates adequate sealing between the components.

Another embodiment of cold end 42 is illustrated in FIG. 4. The cold end embodiment of FIG. 4 may have some features in common with both of the cold end embodiments of FIGS. 2 and 3. For example, cold end 42 of FIG. 4 may include a connecting flange 116, a plunger housing 118, and an inlet manifold 120. However, cold end 42 of FIG. 4 may not include an outlet manifold or a spacer plate. Connecting flange 116 may be connected directly to plunger housing 118, and inlet manifold 120 may be connected at an opposing side to (i.e., at the lower side of) plunger housing 118. As in all embodiments, fasteners 66 may connect these components to each other.

Connecting flange 116 of FIG. 4 may be similar to connecting flange 58 of FIG. 2. In particular, connecting flange 116 may have a generally cylindrical body, with bores 68 formed therein and arranged in a ring around axis 32. Each of bores 68 may be configured to receive a different guide nut 70. Push rod sleeves 72 may be threadingly engaged with guide nuts 70, thereby connecting cold end 42 to warm end 40. Seals (e.g., liquid and/or vapor seals) 76 may be disposed between guide nuts 70 and the wall of bore 68, if desired. However, in contrast to connecting flange 58, connecting flange 116 may include a center portion that protrudes downward toward plunger housing 118 and contains passage segments 96c and center cavity 98.

Plunger housing 118 of FIG. 4 may be similar to plunger housing 108 of FIG. 3. In particular, plunger housing 118 may have a generally cylindrical body, with hollow barrels 82 formed therein in a ring around axis 32 to receive plungers 80. In addition, outlet check valves 100 and springs 106 may be housed within a center of plunger housing 118 (e.g., at a location below the center portion of connecting flange 116), and portions of each passage 96 (e.g., segments 96a and 96b) may be routed through plunger housing 118 between barrels 82 and outlet check valves 100. Unlike the other plunger housing embodiments, plunger housing 118 may be solid at its center, with a generally consistent axial thickness.

Inlet manifold 120 of FIG. 4 may be similar to inlet manifold 110 of FIG. 3. In particular, inlet manifold 120 may be cylindrical and generally plate-like with a consistent axial thickness. Bores 84 may be formed therein to receive inlet check valves 87 in the same configuration of manifold 110. Stems 90 of inlet check valves 87 may be slidingly received within guides 88, and bases 92 may selectively engage seats 94 to inhibit high-pressure flow from exiting barrels 82 during the extending strokes of plungers 80. In contrast to inlet manifold 110, however, inlet check valves 87 of inlet manifold 120 may extend a distance into plunger housing 118 when moving to their open positions.

The primary difference between the cold-end embodiment of FIG. 4 and the other embodiments may be the use of plunger liners 122. In particular, rather than plungers 80 riding directly inside barrels 82 formed in plunger housing 118, plungers 80 may ride within liners 122 that reside in barrels 82. Liners 122 may each have a generally cylindrical body, with an internal bore 124 that slidingly receives plungers 80. An outer surface of liners 122 may be threaded and configured to engage corresponding threads inside barrels 82. In one embodiment, the threading may exist only at an upper end portion of liners 122, such that a remaining portion (e.g., a majority of an axial thread-free length) of liners 122 hangs inside barrels 82 with some clearance between liners 122 and inner walls of barrels 82. This clearance may allow for some expansion and contraction of liners 122 caused by thermal and/or pressure gradients of pump 14. An upper end of liners 122 may be flanged and, in some instance, includes external features (e.g., a hexagonal shape) that is engaged by a corresponding tool and used to connect liners 122 to barrels 82 inside bores 124 (i.e., to turn liners 122 during threading engagement). As liners 122 are threaded into bores 124, a distal tip end of liners 122 (i.e., the end opposite the flanged end) may engage a seat inside barrels 82 and seal against the seat to help maintain desired pressures inside liners 122 during reciprocation of plungers 80.

Although liners 122 are shown only in combination with the other components of the FIG. 4 cold end embodiment, it is contemplated that any of the disclosed cold-end embodiments could benefit from the use of liners 122. In particular, by using liners 122, the machining tolerances of plunger housing 118 may be relaxed somewhat, which may help to reduce a cost of plunger housing 118. In addition, because liners 122 include the high-tolerance geometry originally included in the other plunger housing designs, the high-tolerance geometry may be easier to achieve. That is, liners 122 are smaller components when compared to the plunger housings, making them easier to move and position during machining. In addition, because each liner 122 is generally cylindrical and includes only a single bore, the process of producing the high-tolerance geometry may be altered to a more precise and/or lower-cost process. Specifically, the high-tolerance geometry of liner 122 may be machined using a lathe, instead of a mill as may have been required when the geometry was formed in the plunger housings. Finally, liners 122 may be replaceable wear items, allowing for a fast and low-cost remanufacturing process. And it may be simpler to apply homogenous coatings to the inner surfaces of liners 122 due to the opposing open ends thereof, which may allow for improved quality and/or cheaper fabrication.

### INDUSTRIAL APPLICABILITY

The disclosed pump finds potential application in any fluid pumping application. For example the disclosed pump may be used in mobile (e.g., locomotive) or stationary (e.g., power generation) application having an internal combustion engine that consumes the fluid pressurized by the disclosed pump. The disclosed pump finds particular applicability in cryogenic applications, for example in applications having engines that burn LNG fuel. Operation of pump system 10 will now be explained.

Referring to FIG. 1, when mechanical input 38 is rotated by power source 16, load plate 50 may be driven to undulate in an axial direction. This undulation may result in translational movement of tappets 52 and corresponding movements of pushrods 54. As each pushrod 54 retracts from a corresponding barrel 82 (or liner 122), plunger 80 may be pulled upward. In addition, the pressure of the fuel inside tank 12 may help to lift plunger 80 to its retracted position in some applications. As plunger 80 moves upward within barrel 82, the fluid in tank 12 may be drawn and/or be pushed past inlet check valve 87 into barrel 82. As pushrod 54 extends back into barrel 82, pushrod 54 may force plunger 80 back downward. The downward movement of plunger 80 may drive the fluid from barrel 82 (or liner 122) at an elevated pressure. The high-pressure fluid may flow through passage 96 past outlet check valve 100 to central cavity 98, and from central cavity 98 out of pump 14 via passage 18.

The disclosed pump may provide a high-pressure supply of fuel in a compact, simple, and robust configuration. The disclosed pump may be compact due to the strategic location of valves inside uniquely designed manifolds, which helps to reduce an axial and radial size of the pump. The disclosed pump may also be simple and robust due to the use of common manifolds, which may to help reduce part count. In addition, the use of replaceable plunger liners within the manifolds may allow for uncomplicated and low-cost remanufacturing of the pump.

It will be apparent to those skilled in the art that various modifications and variations can be made to the pump of the present disclosure. Other embodiments of the pump will be apparent to those skilled in the art from consideration of the specification and practice of the pump disclosed herein. It is intended that the specification and examples be considered as exemplary only, with a true scope being indicated by the following claims and their equivalents.

What is claimed is:

1. A liner for a cryogenic pump having a manifold, comprising:
a generally cylindrical body having a top end and a bottom end;
an internal bore formed in the generally cylindrical body and passing from the top end through the bottom end, the internal bore being configured to receive a plunger of the cryogenic pump; and
a flange located at the top end and configured to engage the manifold.

2. The liner of claim 1, further including threads located on an outer surface of the generally cylindrical body and configured to connect the generally cylindrical body to walls of the barrel.

3. The liner of claim 2, wherein a majority of an axial length of the outer surface is thread-free.

4. A manifold for a cryogenic pump, comprising:
a generally cylindrical body having a top end and a bottom end;
a plurality of bores arranged in a ring around a central axis of the generally cylindrical body, each of the plurality of bores being configured to communicate with a different plunger barrel of the cryogenic pump; and
at least one inlet orifice in fluid communication with each of the plurality of bores.

5. The manifold of claim 4, wherein the at least one inlet orifice include a plurality of inlet orifices in fluid communication with each of the plurality of bores.

6. The manifold of claim 4, further including a seat formed between each of the plurality of bores and the at least one inlet orifice, the seat configured to be engaged by an inlet check valve to selectively inhibit fluid flow between the at least one inlet orifice and a corresponding one of the plurality of bores.

7. The manifold of claim 6, further including a guide formed within the plurality of bores of the generally cylindrical body and configured to receive a stem of the inlet check valve.

8. The manifold of claim 6, further including:
a central discharge cavity formed within the generally cylindrical body; and
a passage configured to direct fluid discharged from each of the different plunger barrels to the central discharge cavity.

9. The manifold of claim 8, further including a seat formed within the passage and configured to be engaged by an outlet check valve to selectively inhibit fluid flow between a corresponding one of the different plunger barrels and the central discharge cavity.

10. The manifold of claim 9, wherein:
the generally cylindrical body includes a flange portion and a center portion that protrudes from the flange portion;
the plurality of bores are formed in the flange portion; and
the central discharge cavity is formed in the center portion of the generally cylindrical body.

11. The manifold of claim 10, further including a radial discharge passage extending from the central discharge cavity radially outward through the generally cylindrical body.

12. The manifold of claim 9, wherein the manifold is plate-like and has a generally consistent axial thickness.

13. The manifold of claim 9, wherein the passage consists of multiple segments oriented at different angles.

14. The manifold of claim 13, wherein:
the multiple segments include a first segment, a second segment, and a third segment;
the second segment is fluidly connected between the first and third segments; and
the first and third segments are oriented obliquely relative to an axis of the generally cylindrical body.

15. The manifold of claim 14, wherein the second segment is generally parallel with the axis of the generally cylindrical body and configured to align with the outlet check valve.

16. A cryogenic pump, comprising:
a plunger housing having a plurality of barrels formed in a ring around a central axis;
a plurality of plungers, each reciprocatingly disposed within a different one of the plurality of barrels;
an inlet manifold connected to an end of the plunger housing, and having:
a plurality of bores, each being open to a corresponding one of the plurality of barrels; and
at least one orifice in fluid communication with each of the plurality of bores; and
an inlet check valve disposed within the inlet manifold between each of the plurality of bores and the at least one orifice, the inlet check valve being movable to selectively allow fluid flow between the at least one orifice and a corresponding one of the plurality of barrels.

17. The cryogenic pump of claim 16, wherein:
the plunger housing has a central cavity; and
the inlet manifold includes a flange portion in which the plurality of bores are formed, and a central portion that extends into the central cavity.

18. The cryogenic pump of claim 17, further including a central discharge cavity formed in the central portion of the inlet manifold and in fluid communication with each of the plurality of bores.

19. The cryogenic pump of claim 18, further including a plurality of outlet check valves disposed in the central portion of the inlet manifold, each of the plurality of outlet check valves located between the central discharge cavity and a corresponding one of the plurality of bores.

20. The cryogenic pump of claim 16, further including an outlet manifold connected to an end of the plunger housing opposite the inlet manifold, the outlet manifold having a central discharge cavity in fluid communication with each of the plurality of bores.

21. The cryogenic pump of claim 20, wherein:
the plunger housing includes a recess located inward of the plurality of barrels; and
the outlet manifold is located at least partially inside the recess.

22. The cryogenic pump of claim 20, wherein the plunger housing includes a plurality of passages, each of the plurality of passages connecting a corresponding one of the plurality of bores in the inlet manifold with the central discharge cavity in the outlet manifold.

23. The cryogenic pump of claim 22, further including a plurality of outlet check valves disposed inside the plunger housing, each of the plurality of outlet check valves being associated with a different one of the plurality of passages.

24. The cryogenic pump of claim 16, further including a plurality of plunger liners, each of the plurality of plunger liners being disposed within a different one of the plurality of barrels and configured to slidingly receive a corresponding one of the plurality of plungers.

25. The cryogenic pump of claim 24, wherein each of the plurality of plunger liners includes:
a generally cylindrical body having a top end and a bottom end;
an internal bore formed in the generally cylindrical body and passing from the top end through the bottom end, the internal bore being configured to receive the corresponding one of the plurality of plungers;
a flange located at the top end and configured to be used to connect the generally cylindrical body to the different one of the plurality of barrels; and
threads located on an outer surface of the generally cylindrical body and configured to connect the generally cylindrical body to a wall of the different one of the plurality of barrels.
